(19) United States
(12) Patent Application Publication
(10) Pub. No.: US 2023/0159372 A1
(43) Pub. Date: May 25, 2023

(54) OPTICAL FIBER FORMING APPARATUS

(71) Applicant: CORNING INCORPORATED, Corning, NY (US)

(72) Inventors: Tammy Michelle Hoffmann, Wilmington, NC (US); Nikolaos Pantelis Kladias, Horseheads, NY (US); Michael Thomas Prezioso, Castle Hayne, NC (US)

(21) Appl. No.: 17/981,730

(22) Filed: Nov. 7, 2022

Related U.S. Application Data
(60) Provisional application No. 63/281,976, filed on Nov. 22, 2021.

(51) Int. Cl. C03B 37/029; C03B 37/027

(52) U.S. Cl. CPC C03B 37/029; C03B 37/02718; C03B 2205/42

(57) ABSTRACT

An optical fiber forming apparatus comprises: a draw furnace; a tube that extends into the passageway of the draw furnace; and a cooling device at an outlet of the tube, the cooling device comprising: one or more bodies having a top surface and an opposing bottom surface, an opening within the body extending from the top surface through the body to the bottom surface, wherein the opening is configured to pass an optical fiber through the body, and one or more gas outlets within the body configured to direct gas to contact the optical fiber as it passes through the opening.

This application claims the benefit of priority to U.S. Provisional Patent Application Ser. No. 63/281,976 filed on Nov. 22, 2021, the content of which is relied upon and incorporated herein by reference in its entirety.

### TECHNICAL FIELD

This disclosure relates to the technical field of optical fibers.

### BACKGROUND

Conventional manufacturing processes for producing optical fibers generally include drawing an optical fiber downward from a draw furnace and along a linear pathway through multiple stages of production in an optical fiber draw tower. Once drawn from the draw furnace, the optical fiber may be cooled in a regulated manner to achieve desired fiber properties.

To meet consumer demand for optical fiber, it is desirable to increase optical fiber production within existing optical fiber draw towers. To increase optical fiber production, the rate at which the optical fiber is drawn is generally increased. However, increased draw rates may lead to flow instabilities that arise due to natural convection in the ambient air between the exit of draw furnace and the entrance of a downstream Slow Cooling Device (SCD), which may lead to decreased quality of the optical fiber.

### SUMMARY

According to a first embodiment of the present disclosure, an optical fiber forming apparatus comprises: optical fiber forming apparatus comprises: a draw furnace comprising: (i) a muffle with an inner surface, (ii) an axial opening below the muffle, the inner surface of the muffle defining a passageway extending through the axial opening, and (iii) an upper inlet into the passageway; and a tube that extends into the passageway of the draw furnace above the axial opening, the tube having (i) an outer surface and the inner surface of the muffle surrounds the outer surface of the tube with a space separating the outer surface of the tube from the inner surface of the muffle, (ii) an inner surface that defines a second passageway extending through the tube, (iii) an inlet into the second passageway of the tube, (iii) an outlet out of the second passageway of the tube; and a cooling device at an outlet out of the second passageway of the tube the cooling device comprising: one or more bodies having a top surface and an opposing bottom surface, an opening within the body extending from the top surface through the body to the bottom surface, wherein the opening is configured to pass an optical fiber through the body, and one or more gas outlets within the body configured to direct gas to contact the optical fiber as it passes through the opening.

A second embodiment of the present disclosure may include the first embodiment, wherein inert gas flows through the upper inlet and into the passageway of the draw furnace and forms separate streams, one of which flows through the passageway of the draw furnace in the space between the inner surface of the muffle and the outer surface of the tube and out the axial opening of the draw furnace, and the other of which flows into the inlet of the tube, through the second passageway of the tube, and out the outlet of the tube.

A third embodiment of the present disclosure may include the second embodiment, wherein the inert gas comprises one or more of argon, nitrogen or helium.

A fourth embodiment of the present disclosure may include the first embodiment, further comprising: a first heating element that heats the passageway of the draw furnace throughout a first range that encompasses at least a portion of the passageway of the draw furnace above the inlet of the tube; and a second heating element that heats the passageway of the draw furnace throughout a second range that encompasses at least a portion of the passageway of the draw furnace above the first range.

A fifth embodiment of the present disclosure may include the first embodiment, further comprising: an optical fiber preform disposed within the passageway of the draw furnace; optical fiber drawn from the optical fiber preform that extends through the second passageway of the tube; and a first heating element that heats the passageway of the draw furnace throughout a first range that encompasses a tip of the optical fiber preform.

A sixth embodiment of the present disclosure may include the fifth embodiment, further comprising: a second heating element that heats the passageway of the draw furnace throughout a second range that encompasses a portion of the passageway above a main body of the optical fiber preform.

A seventh embodiment of the present disclosure may include the sixth embodiment, further comprising: a third heating element that heats the passageway of the draw furnace throughout a third range that encompasses a portion of the second passageway of the tube.

An eighth embodiment of the present disclosure may include the fifth embodiment, wherein the optical fiber exits the outlet of the tube at a rate of at least 20 meters per second and has a diameter after exiting the outlet of the tube, the standard deviation (σ) of which diameter is less than 0.06 μm at frequencies of 0.1 Hz, 1 Hz, and 10 Hz.

A ninth embodiment of the present disclosure may include the first embodiment, wherein the inlet of the tube has an inner diameter of 1.27 cm to 2.54 cm.

A tenth embodiment of the present disclosure may include the first embodiment, wherein the cooling device further comprises one or more gas inlets fluidly coupled to the gas outlets.

An eleventh embodiment of the present disclosure may include the first embodiment, wherein the cooling device opening has a diameter of about 2 mm to about 100 mm

A twelfth embodiment of the present disclosure may include the first embodiment, wherein the one or more gas outlets is a plurality of nozzles.

A thirteenth embodiment of the present disclosure may include the twelfth embodiment, wherein a volumetric flow rate of gas from each nozzle is about 5 slpm to about 100 slpm.

A fourteenth embodiment of the present disclosure may include the first embodiment, wherein the one or more gas outlets is a singular slot, wherein the slot has a width of about 50 microns to about 2 mm.

A fifteenth embodiment of the present disclosure may include the first embodiment, wherein the gas outlets direct gas toward the optical fiber at an angle of about 15 degrees to about 90 degrees from a vertical axis running in a direction of fiber conveyance.

A sixteenth embodiment of the present disclosure may include the first embodiment, wherein the gas outlets direct gas toward the optical fiber at an angle of about 15 degrees to about 90 degrees from a vertical axis running in a direction of fiber counter-conveyance.

A seventeenth embodiment of the present disclosure may include an optical fiber forming apparatus comprising: a draw furnace comprising: (i) a muffle with an inner surface, (ii) an axial opening below the muffle, the inner surface of the muffle defining a passageway extending through the axial opening, and (iii) an upper inlet into the passageway; and a tube that extends into the passageway of the draw furnace above the axial opening, the tube having (i) an outer surface and the inner surface of the muffle surrounds the outer surface of the tube with a space separating the outer surface of the tube from the inner surface of the muffle, (ii) an inner surface that defines a second passageway extending through the tube, (iii) an inlet into the second passageway of the tube, (iv) an outlet out of the second passageway of the tube; a cooling device at an outlet out of the second passageway of the tube the cooling device comprising: one or more bodies having a top surface and an opposing bottom surface, an opening within the body extending from the top surface through the body to the bottom surface, wherein the opening is configured to pass an optical fiber through the body, and one or more gas outlets within the body configured to direct gas to contact the optical fiber as it passes through the opening; a flame reheating device downstream from the draw furnace, wherein the flame reheating device is configured to heat the optical fiber by at least 100 degrees Celsius at a heating rate greater than 10,000 degrees Celsius/second; and a slow cooling device downstream of the draw furnace.

An eighteenth embodiment of the present disclosure may include the seventeenth embodiment, wherein inert gas flows through the upper inlet and into the passageway of the draw furnace and forms separate streams, one of which flows through the passageway of the draw furnace in the space between the inner surface of the muffle and the outer surface of the tube and out the axial opening of the draw furnace, and the other of which flows into the inlet of the tube, through the second passageway of the tube, and out the outlet of the tube.

A nineteenth embodiment of the present disclosure may include the eighteenth, wherein the inert gas comprises one or more of argon, nitrogen or helium.

A twentieth embodiment of the present disclosure may include the eighteenth embodiment, wherein the inert gas comprises no helium.

### BRIEF DESCRIPTION OF THE DRAWINGS

In the Figures:

FIG. 1 is a schematic elevational view of an embodiment of an optical fiber forming apparatus, illustrating a draw furnace with a muffle with an inner surface that defines a passageway, and a tube extending into the passageway, with optical fiber drawn from an optical fiber preform extending through the tube;

FIG. 2 is a view of area II of FIG. 1, illustrating the tube separated from the inner surface of the muffle and inert gas flowing through a second passageway of the tube as an inner stream and between the tube and the inner surface of the muffle as an outer steam;

FIG. 3 schematically depicts a cooling device of the optical fiber forming apparatus, according to one or more embodiments shown and described herein;

FIG. 4A-4B schematically depicts a cross-sectional view of the cooling device of the optical fiber forming apparatus, according to one or more embodiments described herein;

FIG. 5 schematically depicts an enlarged perspective view of an optical fiber within the optical fiber forming apparatus, according to one or more embodiments described herein;

FIG. 6 depicts the stream function plot of gas flow below the forming tube with a cooling device, according to one or more embodiments described herein;

FIG. 7 is a schematic elevational view of an embodiment of an optical fiber forming apparatus.

### DETAILED DESCRIPTION

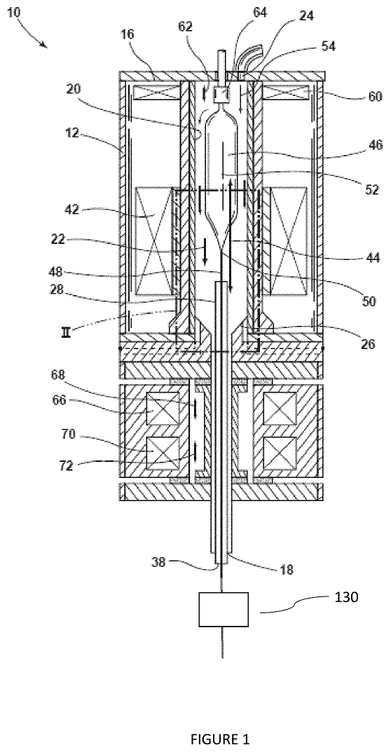

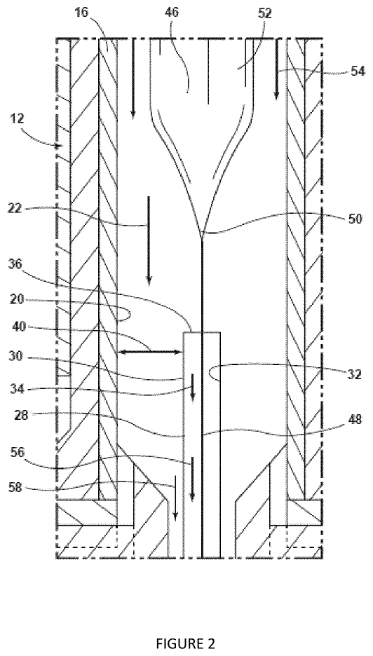

Referring now to FIGS. 1-2, an embodiment of an optical fiber forming apparatus 10 is illustrated. The optical fiber forming apparatus 10 includes a draw furnace 12. The draw furnace 12 includes a muffle 16 and an axial opening 18 below the muffle 16. The muffle 16 has an inner surface 20. The inner surface 20 defines a passageway 22 that extends through the axial opening 18. The draw furnace 12 further includes an upper inlet 24 into the passageway 22. The muffle 16 further includes a narrowing 26 where the diameter of the passageway 22 narrows as the narrowing 26 progresses towards the axial opening 18.

The optical fiber forming apparatus 10 further includes a tube 28. The tube 28 extends into the passageway 22 of the draw furnace 12. The tube 28 is thus at least partially disposed between the axial opening 18 and the upper inlet 24 into the passageway 22. In embodiments such as the illustrated embodiment, the tube 28 extends through the axial opening 18. In other embodiments, the tube 28 is entirely within the passageway 22 and does not extend through the axial opening 18. In any event, at least a portion of the tube 28 is disposed above the axial opening 18 within the passageway 22. The tube 28 extends upwards above the narrowing 26.

The tube 28 includes an outer surface 30, an inner surface 32 that defines a second passageway 34 extending through the tube 28, an inlet 36 into the second passageway 34 of the tube 28, and an outlet 38 out of the second passageway 34 of the tube 28. The inlet 36 of the tube 28 is disposed within the passageway 22 of the draw furnace 12, above the narrowing 26. The outlet 38 need not be disposed within the passageway 22 of the draw furnace 12 but can be so disposed. The inner surface 20 of the muffle 16 surrounds the outer surface 30 of the tube 28 for the portion of the tube 28 that is disposed within the passageway 22 of the draw furnace 12. A space 40 separates the outer surface 30 of the tube 28 from the inner surface 20 of the muffle 16. That is, the tube 28 does not touch the muffle 16 within the passageway 22 of the draw furnace 12.

The draw furnace 12 further includes a first heating element 42 that is in thermal communication with the muffle 16. The first heating element 42 heats the passageway 22 of the draw furnace 12 throughout at least a first range 44 that encompasses at least a portion of the passageway 22 of the draw furnace 12 above the inlet 36 of the tube 28. In operation of the optical fiber forming apparatus 10, an optical fiber preform 46 is disposed within the passageway 22 of the draw furnace 12. The first heating element 42 heats the optical preform 46 sufficiently to decrease the viscosity of the optical fiber preform 46 and allow an optical fiber 48 to be drawn from the optical fiber preform 46. The first range 44 that the first heating element 42 heats encompasses a tip 50 of the optical fiber preform 46, which is where the optical fiber preform 46 transitions to the optical fiber 48 drawn therefrom. In embodiments, the first heating element 42 heats the first range 44 to a temperature of 1700° C. to 2000° C., such as 1700° C., 1800° C., 1900° C., or 2000° C., or any range having any two of these values as endpoints. The passageway 22 of the draw furnace 12 within the first range 44 may have a temperature which is elevated relative to the rest of the passageway 22. The first range 44 can further encompass a main body 52 of the optical fiber preform 46, which is above the tip 50 and from which the tip 50 descends.

The optical fiber 48 drawn from the optical fiber preform 46 extends through the second passageway 34 of the tube 28. In other words, the optical fiber 48 drawn from the optical preform 46 extends into the inlet 36 of the tube 28, then through the second passageway 34 of the tube 28, and then out of the outlet 38 of the tube 28. In embodiments, the optical fiber 48 that enters into the inlet 36 of the tube 28 has a diameter that is greater than 125 μm, while the inlet 36 of the tube 28 has an inner diameter of 1.27 cm to 2.54 cm. An inner diameter of the tube 28 at the inlet 36 smaller than 1.27 cm poses an appreciable risk that the optical fiber 48 could contact the inlet 36 or the inner surface 32 of the tube 36. An inner diameter of the tube 28 at the inlet 36 larger than 2.54 cm would likely result in a sufficiently large distance between the inner surface 32 of the tube 28 and the optical fiber 48 that causes convection of inert gas 54 thus negatively affecting diameter variability. In embodiments, the inner diameter of the tube 28 at the inlet 36 is 100 to 200 times larger than the diameter of the optical fiber 48 that enters the inlet 36 of the tube 28. A tensioning station (not shown) is in contact with the optical fiber 48 and maintains the optical fiber 48 at a desired tension.

In embodiments, inert gas 54 flows through the upper inlet 24 of the draw furnace 12 and into the passageway 22 of the draw furnace 12. The inert gas 54 then forms separate streams—an inner stream 56 and an outer stream 58. The inner stream 56 flows into the inlet 36 of the tube 28, through the second passageway 34 of the tube 28, and out the outlet 38 of the tube 28. The outer stream 58 flows though the passageway 22 of the draw furnace 12 in the space 40 between the inner surface 20 of the muffle 16 and the outer surface 30 of the tube 28 and then out the axial opening 18 of the draw furnace 12.

In embodiments, the inert gas 54 comprises argon, nitrogen, or helium. In embodiments, the inert gas 54 comprises argon or nitrogen, or a combination of argon and nitrogen. In embodiments, the inert gas 54 comprises one or more of argon and nitrogen, and less than 1 percent by volume helium. In embodiments, the inert gas 54 comprises no intentionally included helium. In embodiments, the inert gas 54 comprises essentially pure argon (e.g., more than 99 percent by volume argon).

In embodiments, the tube 28 comprises one or more graphite, quartz, and stainless steel. In embodiments, the tube 28 is stainless steel.

In embodiments, the optical fiber forming apparatus 10 further includes a second heating element 60. The second heating element 60 is disposed vertically above the first heating element 42. The second heating element 60 heats the passageway 22 of the draw furnace 12 throughout at least a second range 62 that encompasses at least a portion of the passageway 22 of the draw furnace 12 above the first range 44. The second range 62 encompasses a portion of the passageway 22 above the main body 52 of the optical fiber preform 46. In embodiments, the second range 62 encompasses a boule 64 that supports the optical fiber preform 46.

In embodiments, the optical fiber forming apparatus 10 further includes a third heating element 66. The third heating element 66 is disposed vertically below the first heating element 42. The third heating element 66 heats the passageway 22 of the draw furnace 12 throughout a third range 68 that encompasses a portion of the second passageway 34 of the tube 28. The third range 68 is vertically below the first range 44. The third heating element 66 thus heats both a portion of the passageway 22 of the draw furnace 12 disposed around the tube 28 as well as the second passageway 34 of the tube 28.

In embodiments, the optical fiber forming apparatus 10 further includes a cooling element 70. The cooling element 70 is disposed vertically below the first heating element 42. The cooling element 70 cools the passageway 22 of the draw furnace 12 throughout a fourth range 72 that encompasses a portion of the second passageway 34 of the tube 28. The fourth range 72 is vertically below the first range 44. The cooling element 70 cools the optical fiber 48 drawn from the optical fiber preform 46 as the optical fiber 48 passes through the second passageway 34 of the tube 28 toward a tensioning station (not shown).

As will be further demonstrated in the examples below, the optical fiber forming apparatus 10 that includes the tube 28 extending throughout a portion of the passageway 22 of the draw furnace 12 produces optical fiber 48 that has a diameter, the standard deviation of which is within an improved and acceptable tolerance. In embodiments, the optical fiber 48 exits the outlet 38 of the tube 28 at a rate of at least 20 m/s and has a diameter after exiting the outlet 38 of the tube 28, the standard deviation of which diameter is less than 0.1 μm at frequencies of 0.1 Hz, 1 Hz, and 10 Hz. In embodiments, the optical fiber 48 exits the outlet 38 of the tube 28 at a rate of at least 20 m/s and has a diameter after exiting the outlet 38 of the tube 28, the standard deviation of which diameter is less than 0.1 μm at frequencies of 0.06 Hz, 1 Hz, and 10 Hz.

The position of the tube 28 within the passageway 22 of the draw furnace 12 is adjustable. This aspect provides many advantages. The inlet 36 of the tube 28 can be extended relatively close to the tip 50 of the optical fiber preform 46 and, thus, protect the optical fiber 48 from disturbances in flow of the inert gas 54 during much of the period of time while the optical fiber 48 is cooling. In the same manner, the length of the tube 28 between the inlet 36 of the tube 28 and the outlet 38 of the tube 28 can be adjusted as desired to protect the optical fiber 48 from disturbances from the inert gas 54 or ambient air while the optical fiber 48 is cooling. In some circumstances, it may be desirable to size the length of the tube 28 to extend out of the passageway 22 through the axial opening 18, to allow additional distance and time for the optical fiber 48 to cool before becoming exposed to flow instabilities caused by the temperature difference between the optical fiber 48 and the ambient air.

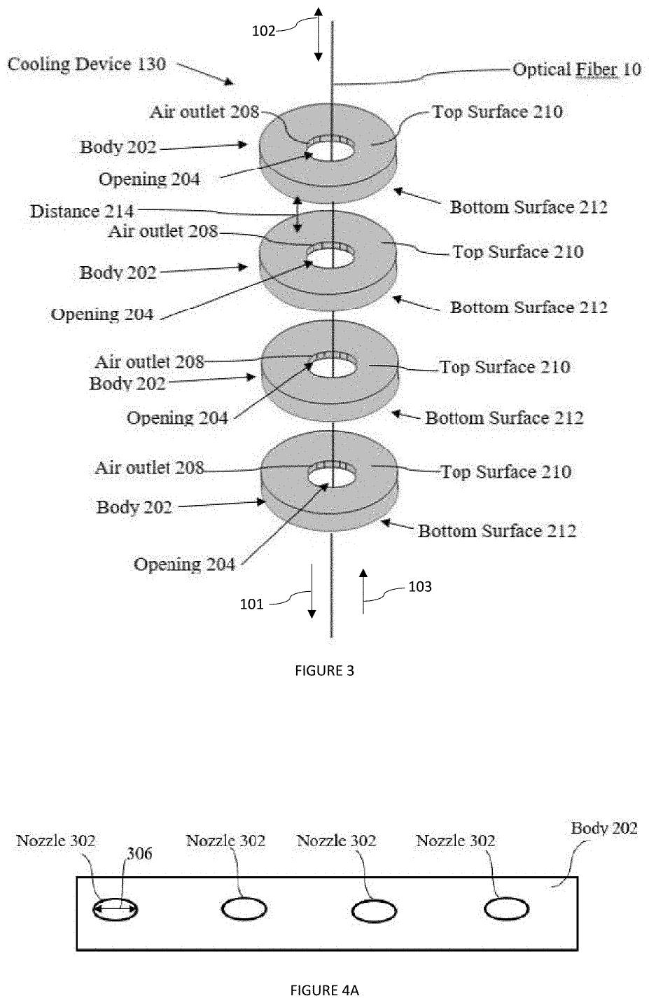

Downstream from the tube 28, the optical fiber enters a cooling device 130. As depicted in FIG. 3, the cooling device 130 comprises one or more bodies 202. In some embodiments, the cooling device has a length of about 10 inches to about 60 inches. In some embodiments, the cooling device has a length of about 20 inches to about 60 inches, or about 30 inches to about 60 inches, or about 40 inches to about 60 inches, or about 50 inches to about 60 inches.

In some embodiments, as depicted in FIG. 3, the cooling device 130 comprises 4 bodies 202. The cooling device 130 may contain more or less bodies 202 than depicted in the exemplary embodiment, for example 1, 2, 3, 5, or 6 bodies 202. Each body 202 has a top surface 210 and an opposing bottom surface 212. The bottom surface faces the fiber conveyance direction 101. The top surface 210 faces the counter-conveyance direction 103. In some embodiments, a distance 214 from a bottom surface 210 of a body 202 to a top surface 210 of an adjacent body 202 is about 2 inches to about 10 inches. In some embodiments, the distance 214 is about 4 inches to about 10 inches, or about 6 inches to about 10 inches, or about 8 inches to about 10 inches. In some embodiments, the distance 214 is about 2 inches to about 8 inches, or about 2 inches to about 6 inches, or about 2 inches to about 4 inches.

Each body 202 has an opening 204 extending from the top surface 210 through the body 202 to the bottom surface 212. The optical fiber 12 passes through the opening 204. In some embodiments, the opening 204 has a diameter of about 2 mm to about 100 mm. In some embodiments, the opening 204 has a diameter of about 10 mm to about 100 mm, or about 20 mm to about 100 mm, or about 30 mm to about 100 mm, or about 40 mm to about 100 mm, or about 50 mm to about 100 mm, or about 60 mm to about 100 mm, or about 70 mm to about 100 mm, or about 80 mm to about 100 mm, or about 90 mm to about 100 mm. In some embodiments, the opening 204 has a diameter of about 2 mm to about 90 mm. In some embodiments, the opening 204 has a diameter of about 2 mm to about 80 mm. In some embodiments, the opening 204 has a diameter of about 2 mm to about 70 mm. In some embodiments, the opening 204 has a diameter of about 2 mm to about 60 mm. In some embodiments, the opening 204 has a diameter of about 2 mm to about 40 mm. In some embodiments, the opening 204 has a diameter of about 2 mm to about 20 mm. In some embodiments, the opening 204 has a diameter of about 2 mm to about 10 mm.

One or more gas outlets 208 within the body 202 direct gas toward the optical fiber 10 passing through the opening 204 to cool the optical fiber 10. In embodiments, the gas outlets 208 direct gas toward the optical fiber at an angle of 90 degrees from the vertical axis. In embodiments, the gas outlets 208 direct gas toward the optical fiber at an angle of 30 degrees from the vertical axis. In embodiments, the gas outlets 208 direct gas toward the optical fiber at an angle of about 15 degrees to about 90 degrees from a vertical axis running in a direction of fiber conveyance. In embodiments, the gas outlets 208 direct gas toward the optical fiber at an angle of about 15 degrees to about 90 degrees from a vertical axis running in a direction of fiber counter-conveyance. In embodiments, the vertical axis is in the direction of the fiber conveyance 101. The one or more gas outlets 208 direct gas toward the optical fiber 10 at an average velocity of about 20 m/s to about 350 m/s. In some embodiments, gas is directed toward the optical fiber 10 at an average velocity of about 50 m/s to about 350 m/s, or about 50 m/s to about 350 m/s, or about 100 m/s to about 350 m/s, or about 150 m/s to about 350 m/s, or about 200 m/s to about 350 m/s, or about 250 m/s to about 350 m/s, or about 300 m/s to about 350 m/s. One or more gas inlet tubes are fluidly couple to the gas outlets 208 to supply gas. In some embodiments, the gas directed toward the optical fiber is at room temperature (i.e. about 25 degrees Celsius). In some embodiments, the gas directed toward the optical fiber is cooled to less than room temperature prior to directing the gas toward the optical fiber. The gas may be cooled by passing the gas through a heat exchanger or through a vortex cooler tube. In embodiments, the gas is one or more of atmospheric air, helium, argon, nitrogen, or carbon dioxide.

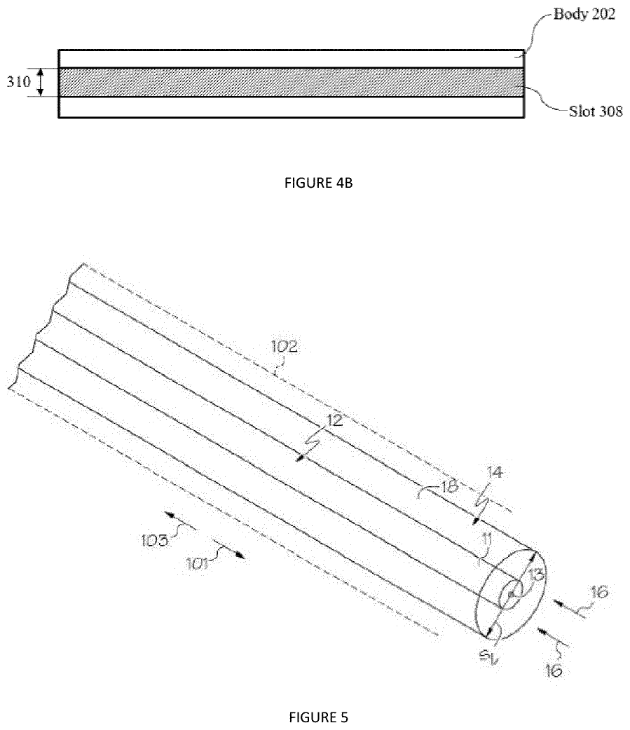

In some embodiments, as depicted in FIG. 4A, the one or more gas outlets 208 are a plurality of nozzles 302 directing gas toward the optical fiber 10. In some embodiments, the plurality of nozzles is 2 to 50 nozzles, preferably 3 to 20 nozzles, more preferably 3 to 12 nozzles. In some embodiments, each nozzle is positioned equidistant from an adjacent nozzle as measured from a center of one nozzle to a center of an adjacent nozzle. In some embodiments, each of the plurality of nozzles has a diameter 306 of about 100 micron to about 5 mm. In some embodiments, each nozzle 302 provides a volumetric flow rate of gas from about 5 slpm to about 8 slpm.

In some embodiments, as depicted in FIG. 4B, the one or more gas outlets 208 is single slot 308 directing gas toward the optical fiber 10. In some embodiments, the slot 308 has a width 310 of about 50 microns to about 2 mm. In some embodiments, the slot 308 has a width 310 of about 100 microns to about 2 mm, or about 500 microns to about 2 mm, or about 1 mm microns to about 2 mm.

Referring to FIG. 5, the cooling device 130 directs the gas 16 toward the optical fiber 12 such that the gas 16 reduces a portion of a gas boundary layer 14 surrounding the optical fiber 12. As the optical fiber 12 moves along the fiber conveyance pathway 102, the gas boundary layer 14 is generated around the optical fiber 12 and comprises gas flowing primarily in the fiber conveyance direction 101. The gas boundary layer 14 extends radially from the optical fiber 12, terminating at a gas layer interface 18 and defining a gas boundary layer span Sb. Without being bound by theory, the gas boundary layer 14 is formed from drag generated by motion of the optical fiber 12 in the fiber conveyance direction 101. In embodiments, the gas boundary layer 14 generally provides thermal insulation to the optical fiber 12, thereby maintaining the optical fiber 12 at a relatively high temperature.

The gas 16 separates at least a portion of the gas boundary layer 14 from the optical fiber 12. By separating at least a portion of the gas boundary layer 14 from the optical fiber 12, the gas 16 may assist in dissipating heat from the optical fiber 12. For example, by separating at least a portion of the gas boundary layer 14 from the optical fiber 12, the thermal insulation provided by the gas boundary layer 14 may be reduced or removed, such that thermal energy of the optical fiber 12 may be dissipated more readily as compared to optical fiber 12 including an undisturbed gas boundary layer 14.

In some embodiments, as the gas 16 is directed toward the optical fiber 12, the gas 16 compresses the gas boundary layer, reducing the gas boundary layer span Sb. By reducing the gas boundary layer span Sb, the thermal insulation provided by the gas boundary layer 14 may be reduced, such that thermal energy of the optical fiber 12 may be dissipated more readily as compared to optical fiber 12 including an undisturbed gas boundary layer 14.

Referring to FIG. 5, in embodiments, the optical fiber 12 includes a cladding 11 positioned around a core 13 of the optical fiber 12. In embodiments, the cladding 11 comprises a refractive index that is different than the core of the optical fiber. For example, in embodiments, the core 13 may have a higher refractive index than the cladding 11, and may assist in restricting light from passing out of the core 13, for example, when the optical fiber 12 is used as an optical waveguide.

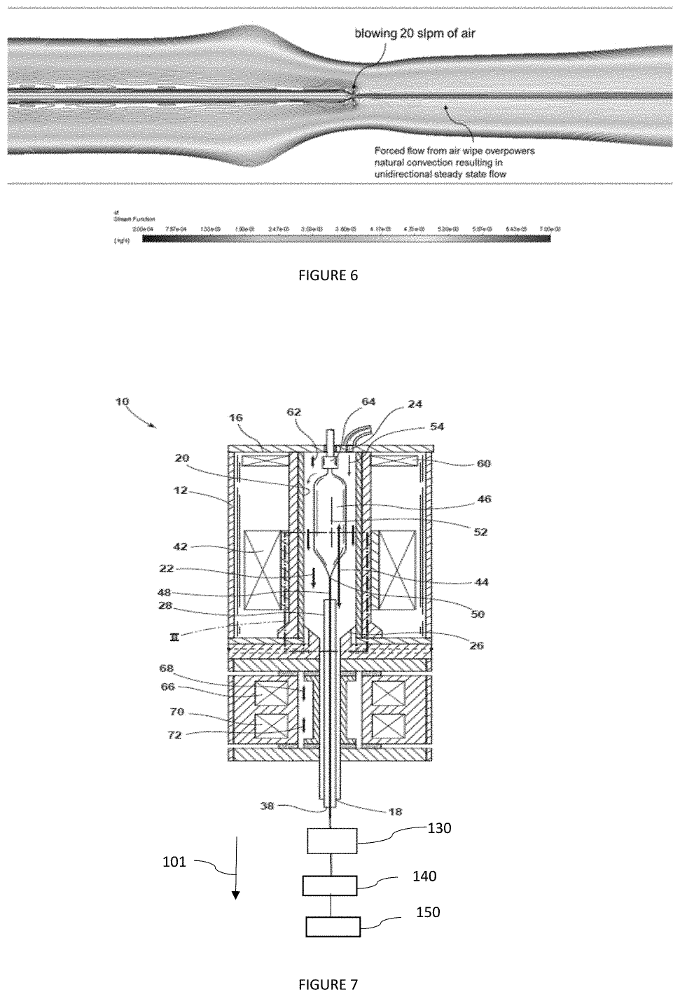

In FIG. 6, the stream function plot shows that with the forced flow of gas from the cooling device 130, the flow below the tube 28 becomes unidirectional and steady. The forced flow from the cooling device 130 overpowers natural convection, thus suppressing flow instabilities.

In embodiments, an optical fiber forming apparatus 10 further includes a reheating device 140. The reheating device 140 is configured to heat the optical fiber 10 to a temperature within a glass transformation temperature range of the optical fiber. By rapidly heating the optical fiber temperature to the glass transformation temperature range, the fictive temperature of the optical fiber can be reduced. As a consequence, Rayleigh scattering from the fiber core may also be reduced.

The reheating device 140 is spaced apart from the draw furnace 10 along the fiber conveyance pathway 102. Embodiments of the reheating device 140 heat the optical fiber from a first temperature at entering the fiber reheating device to a target peak temperature, which is higher than the first temperature. In some embodiments, the first temperature of the optical fiber at entering the fiber reheating device 140 is about 20 degrees Celsius to about 1500 degrees Celsius, for example about 350 degrees Celsius to 500 degrees Celsius. In some embodiments, the target peak temperature of the optical fiber within the fiber reheating device 140 is about 900 degrees Celsius to about 1600 degrees Celsius, for example about 900 degrees Celsius to about 1400 degrees Celsius. Embodiments of the reheating device 140 described herein heat the optical fiber to a target peak temperature greater than 1100 degrees Celsius, or to a target peak temperature greater than 1200 degrees Celsius, or to a target peak temperature greater than 1250 degrees Celsius, or to a target peak temperature greater than 1300 degrees Celsius, or to a target peak temperature greater than 1400 degrees Celsius. Embodiments of the reheating device 140 described herein heat the optical fiber by at least 100 degrees Celsius, or by at least 200 degrees Celsius, or by at least 500 degrees Celsius. Embodiments of the reheating device 130 described herein heat the optical fiber by 300 degrees Celsius to 1400 degrees Celsius. Embodiments of the reheating device 140 described herein heat the optical fiber at a heating rate of greater than about 10,000 degrees Celsius/second, or at a rate of greater than about 20,000 degrees Celsius/second, or at a rate of greater than about 30,000 degrees Celsius/second, or at a rate of greater than about 40,000 degrees Celsius/second, or at a rate of greater than 50,000 degrees Celsius/second. Embodiments of the reheating device 140 described herein heat the optical fiber at a heating rate of 50,000 degrees Celsius/second to 60,000 degrees Celsius/second. The optical fiber is subsequently cooled from the target peak temperature to a second temperature such that a target fictive temperature is obtained in the optical fiber. In some embodiments, the second temperature of the optical fiber is about 700 degrees Celsius to about 1400 degrees Celsius. In some embodiments, the target fictive temperature of the optical fiber is about 800 degrees Celsius to about 1500 degrees Celsius.

In some embodiments, the reheating device 140 is a flame reheating device that comprises one or more flame burners. In some embodiments, each burner is capable of a heating rate of about 1,000 degrees Celsius/second to about 20,000 degrees Celsius/second. In some embodiments, each burner is capable of a heating rate of about 5,000 degrees Celsius/second to about 20,000 degrees Celsius/second. In some embodiments, each burner is capable of a heating rate of about 10,000 degrees Celsius/second to about 20,000 degrees Celsius/second. In some embodiments, each burner is capable of a heating rate of about 15,000 degrees Celsius/second to about 20,000 degrees Celsius/second.

In embodiments as depicted in FIG. 7, downstream from the reheating device 130, the optical fiber 12 enters a first slow cooling device 150. The cooling device 150 includes one or more cooling device heating elements that apply heat to the optical fiber as it passes through the cooling device 150. In some embodiments, the one or more heating elements generally include any elements suitable for generating thermal energy, for example and without limitation, induction coils or the like. The cooling device 150 may assist in reducing the cooling rate of the optical fiber while the optical fiber is in a glass transition region. Reducing the cooling rate of the optical fiber in the glass transition region may generally assist in allowing the glass network of the optical fiber to rearrange in a manner that reduces attenuation resulting from Rayleigh scattering when the optical fiber is utilized as an optical waveguide.

What is claimed is:

1. An optical fiber forming apparatus comprising:
a draw furnace comprising: (i) a muffle with an inner surface, (ii) an axial opening below the muffle, the inner surface of the muffle defining a passageway extending through the axial opening, and (iii) an upper inlet into the passageway; and
a tube that extends into the passageway of the draw furnace above the axial opening, the tube having (i) an outer surface and the inner surface of the muffle surrounds the outer surface of the tube with a space separating the outer surface of the tube from the inner surface of the muffle, (ii) an inner surface that defines a second passageway extending through the tube, (iii) an inlet into the second passageway of the tube, (iv) an outlet out of the second passageway of the tube; and
a cooling device at an outlet out of the second passageway of the tube the cooling device comprising: one or more bodies having a top surface and an opposing bottom surface, an opening within the body extending from the top surface through the body to the bottom surface, wherein the opening is configured to pass an optical fiber through the body, and one or more gas outlets within the body configured to direct gas to contact the optical fiber as it passes through the opening.

2. The optical fiber forming apparatus of claim 1, wherein
inert gas flows through the upper inlet and into the passageway of the draw furnace and forms separate streams, one of which flows through the passageway of the draw furnace in the space between the inner surface of the muffle and the outer surface of the tube and out the axial opening of the draw furnace, and the other of which flows into the inlet of the tube, through the second passageway of the tube, and out the outlet of the tube.

3. The optical fiber forming apparatus of claim 2, wherein
the inert gas comprises one or more of argon, nitrogen or helium.

4. The optical fiber forming apparatus of claim 1 further comprising:
a first heating element that heats the passageway of the draw furnace throughout a first range that encompasses at least a portion of the passageway of the draw furnace above the inlet of the tube; and
a second heating element that heats the passageway of the draw furnace throughout a second range that encompasses at least a portion of the passageway of the draw furnace above the first range.

5. The optical fiber forming apparatus of claim 1 further comprising:
an optical fiber preform disposed within the passageway of the draw furnace;
optical fiber drawn from the optical fiber preform that extends through the second passageway of the tube; and
a first heating element that heats the passageway of the draw furnace throughout a first range that encompasses a tip of the optical fiber preform.

6. The optical fiber forming apparatus of claim 5 further comprising:
a second heating element that heats the passageway of the draw furnace throughout a second range that encompasses a portion of the passageway above a main body of the optical fiber preform.

7. The optical fiber forming apparatus of claim 6 further comprising:
a third heating element that heats the passageway of the draw furnace throughout a third range that encompasses a portion of the second passageway of the tube.

8. The optical fiber forming apparatus of claim 5, wherein
the optical fiber exits the outlet of the tube at a rate of at least 20 meters per second and has a diameter after exiting the outlet of the tube, the standard deviation (σ) of which diameter is less than 0.06 μm at frequencies of 0.1 Hz, 1 Hz, and 10 Hz.

9. The optical fiber forming apparatus of claim 1, wherein
the inlet of the tube has an inner diameter of 1.27 cm to 2.54 cm.

10. The optical fiber forming apparatus of claim 1, wherein the cooling device further comprises one or more gas inlets fluidly coupled to the gas outlets.

11. The optical fiber forming apparatus of claim 1, wherein the cooling device opening has a diameter of about 2 mm to about 100 mm

12. The optical fiber forming apparatus of claim 1, wherein the one or more gas outlets is a plurality of nozzles.

13. The optical fiber forming apparatus of claim 12, wherein a volumetric flow rate of gas from each nozzle is about 5 slpm to about 100 slpm.

14. The system of claim 1, wherein the one or more gas outlets is a singular slot, wherein the slot has a width of about 50 microns to about 2 mm.

15. The system of claim 1, wherein the gas outlets direct gas toward the optical fiber at an angle of about 15 degrees to about 90 degrees from a vertical axis running in a direction of fiber conveyance.

16. The system of claim 1, wherein the gas outlets direct gas toward the optical fiber at an angle of about 15 degrees to about 90 degrees from a vertical axis running in a direction of fiber counter-conveyance.

17. An optical fiber forming apparatus comprising:
a draw furnace comprising: (i) a muffle with an inner surface, (ii) an axial opening below the muffle, the inner surface of the muffle defining a passageway extending through the axial opening, and (iii) an upper inlet into the passageway; and
a tube that extends into the passageway of the draw furnace above the axial opening, the tube having (i) an outer surface and the inner surface of the muffle surrounds the outer surface of the tube with a space separating the outer surface of the tube from the inner surface of the muffle, (ii) an inner surface that defines a second passageway extending through the tube, (iii) an inlet into the second passageway of the tube, (iv) an outlet out of the second passageway of the tube;
a cooling device at an outlet out of the second passageway of the tube the cooling device comprising: one or more bodies having a top surface and an opposing bottom surface, an opening within the body extending from the top surface through the body to the bottom surface, wherein the opening is configured to pass an optical fiber through the body, and one or more gas outlets within the body configured to direct gas to contact the optical fiber as it passes through the opening;
a flame reheating device downstream from the draw furnace, wherein the flame reheating device is configured to heat the optical fiber by at least 100 degrees Celsius at a heating rate greater than 10,000 degrees Celsius/second; and
a slow cooling device downstream of the draw furnace.

18. The optical fiber forming apparatus of claim 17, wherein
inert gas flows through the upper inlet and into the passageway of the draw furnace and forms separate streams, one of which flows through the passageway of the draw furnace in the space between the inner surface of the muffle and the outer surface of the tube and out the axial opening of the draw furnace, and the other of which flows into the inlet of the tube, through the second passageway of the tube, and out the outlet of the tube.

19. The optical fiber forming apparatus of claim 18, wherein the inert gas comprises one or more of argon, nitrogen or helium.

20. The optical fiber forming apparatus of claim 18, wherein the inert gas comprises no helium.
